(19) United States
(12) Patent Application Publication
(10) Pub. No.: US 2018/0033087 A1
(43) Pub. Date: Feb. 1, 2018

(54) CONNECTED DEVICES FOR DETECTING AND RESPONDING TO EVENTS IN AN ENVIRONMENT

(71) Applicant: Accenture Global Solutions Limited, Dublin (IE)

(72) Inventors: Jean-Baptiste Delinselle, Juan les Pins (FR); Pierre Duffaut, La Colle sur Loup (FR); Emmanuel Viale, Cagnes sur Mer (FR)

(21) Appl. No.: 15/661,781

(22) Filed: Jul. 27, 2017

Related U.S. Application Data
(60) Provisional application No. 62/367,694, filed on Jul. 28, 2016.

(51) Int. Cl. G06Q 40/08

(52) U.S. Cl. CPC G06Q 40/08; G06F 3/0481

(57) ABSTRACT

Methods, including computer programs encoded on a computer storage medium, for identifying and responding to events associated with insurance policies. In one aspect, a method includes receiving data from each of multiple, different data sources, accessing information for an insurance policy, determining that data received from the data sources is indicative of an occurrence of an event involving property that is covered by the insurance policy, and in response, providing a message to one or more computing devices.

### CROSS-REFERENCE TO RELATED APPLICATION

This application claims the benefit of U.S. Provisional Application No. 62/367,694, filed Jul. 28, 2016, and titled “Connected Devices for Detecting and Responding to Events in an Environment,” which is hereby incorporated by reference in its entirety.

### TECHNICAL FIELD

This disclosure generally relates to computer-implemented systems, methods, and other techniques for monitoring a condition of an environment using data collected from sensing devices located in the environment.

### BACKGROUND

Advances in communications technologies have provided users with access to a variety of new tools and services. Users are now able to monitor and interact with their homes and vehicles using a variety of different communication devices (e.g., smart phones, personal computers, personal digital assistants (PDAs), etc.), and are doing so with increasing regularity.

### SUMMARY

This specification generally discloses techniques for identifying and responding to events that occur in an environment (e.g., residence, business, vehicle) of a user, based on data collected from sensing devices (e.g., Internet of Things devices) and other data sources. The techniques described herein may include systems, methods, and apparatuses for accessing information representing a user or an environment, connecting to sensing devices located within the environment, such as personal computing devices and appliances, determining the likelihood that various events, such as incidents that pose risk to the health and safety of persons or property in the environment, have occurred or will occur based on insurance information associated with the environment or user and data collected from sensing devices, and perform one or more operations to mitigate such risks based on the determined likelihood. Such operations may, for example, include operations of notifying affected users, agents of the users, or taking action to remedy a detected problem or event.

In some implementations, the techniques described herein may, in certain instances, realize one or more advantages. For example, the present techniques may enable computing systems to collect and make use of data that is produced by multiple, disparate sensing devices and other data sources that might not otherwise communicate with each other. One or more of the techniques described herein for collecting and processing such data may be leveraged in computing systems in highly diverse and dynamic networking environments to perform and improve event detection in an efficient manner.

In some aspects, the subject matter described in this specification may be embodied in methods that may include the actions of receiving, by a computing system, sensor data from each of multiple, different data sources, the sensor data representing a condition of an environment associated with an insurance policyholder, accessing, by the computing system, information for a particular insurance policy of the insurance policyholder, determining, by the computing system and based on the information for the particular insurance policy, that the sensor data received from each of the multiple, different data sources is indicative of an occurrence of a particular event involving property that is covered by the particular insurance policy, and in response to determining that the sensor data received from each of the multiple, different data sources is indicative of an occurrence of the particular event involving property that is covered by the particular insurance policy, providing a message to one or more computing devices.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. In some implementations, the methods may further include the actions of obtaining a relevance score for each of the multiple, different data sources indicating an estimated level of relevance that sensor data received from the respective data source has to the particular insurance policy. In these implementations, determining, based on the information for the particular insurance policy, that sensor data received from each of the multiple, different data sources is indicative of an occurrence of the particular event involving property that is covered by the particular insurance policy may, for instance, include determining, based on the relevance scores obtained for each of the multiple different data sources and the information for the particular insurance policy, that sensor data received from each of the multiple, different data sources is indicative of an occurrence of a particular event involving property that is covered by the particular insurance policy.

In these implementations, the methods may, in some examples, further include the actions of determining, for each of the multiple, different data sources, whether the respective data source corresponds to a device that is registered to the insurance policyholder. In such examples, obtaining the relevance score for each of the multiple, different data sources indicating an estimated level of relevance that sensor data received from the respective data source has to the particular insurance policy may, for instance, include obtaining a relevance score for each of the multiple, different data sources, based on determining whether the respective data source corresponds to a device that is registered to the insurance policyholder. In some of these implementations, the methods may, in some instances, further include the actions of determining, for each of the multiple, different data sources, whether sensor data received from the respective data source reflects one or more characteristics of an environment within which property that is covered by the particular insurance policy is located. In such instances, obtaining the relevance score for each of the multiple, different data sources indicating an estimated level of relevance that sensor data received from the respective data source has to the particular insurance policy may, for example, include obtaining a relevance score for each of the multiple, different data sources, based on determining whether sensor data received from the respective data source reflects one or more characteristics of the environment within which property that is covered by the particular insurance policy is located.

In some examples, determining, based on the information for the particular insurance policy, that sensor data received from each of the multiple, different data sources is indicative of an occurrence of a particular event involving property that is covered by the particular insurance policy may, for instance, include accessing a neural network that has been trained to identify occurrences of events involving insured property given (I) sensor data from one or more data sources and (II) information for an insurance policy, providing input to the neural network that includes (i) sensor data received from each of the multiple, different data sources and (ii) information for the particular insurance policy, and receiving, as output from the neural network, data identifying the particular event involving property that is covered by the particular insurance policy. In these examples, the methods may, in some instances, further include the actions of accessing information for another, different insurance policy, providing input to the neural network that includes (i) sensor data received from each of the multiple, different data sources and (ii) information for the other insurance policy, and receiving, as output from the neural network, data identifying another, different event involving property that is covered by the other insurance policy.

In some implementations, receiving sensor data from each of multiple, different data sources may include receiving sensor data from one or more appliances, and accessing information for the particular insurance policy may include accessing information for a particular insurance policy covering property that includes on the one or more appliances. In some examples, determining, based on the information for the particular insurance policy, that sensor data received from each of the multiple, different data sources is indicative of an occurrence of the particular event involving property that is covered by the particular insurance policy may, in these implementations, include determining, based on the information for the particular insurance policy, that sensor data received from each of the multiple, different data sources is indicative of an occurrence of a particular incident in which a particular one of the appliances experiences one or more failures. In these examples, providing the message to one or more computing devices may, for instance, include providing one or more commands to the particular appliance. In some instances, the methods may, in these examples, further include the actions of selecting, from among a multiple, different third party entities that are each associated with one or more respective events involving insured property, a particular third party entity that is associated with the particular incident. In such instances, providing the message to one or more computing devices may, for example, include providing, to one or more computing devices that are accessible to the particular third party entity, a request to perform one or more services that are associated with the particular incident.

In some examples, providing the message to one or more computing devices may include providing, to one or more computing devices that are accessible to the insurance policyholder, a message suggesting that the insurance policyholder take one or more actions to prevent or suppress an occurrence of the particular incident.

In some implementations, the methods may further include the actions of selecting, from among multiple, different types of insurance claims that are each associated with one or more respective events involving insured property, a particular type of insurance claim that is associated with the particular event. In these implementations, providing the message to one or more computing devices may, for instance, include providing an indication of the particular type of insurance claim to one or more computing devices that are accessible to (i) the insurance policyholder, or (ii) an agent that manages the particular insurance policy.

In some examples, the information for the particular insurance policy may be stored in one or more databases, and providing the message to one or more computing devices may include providing, to one or more computing devices that manage the one or more databases, a request to modify the information for the particular insurance policy. In some of these examples, the information for the particular insurance policy may include information that indicates the particular insurance policy's premium, and providing the request to modify the information for the particular insurance policy may include providing a request to adjust the premium of the particular insurance policy that is indicated in the information for the particular insurance policy. In some instances, the information for the particular insurance policy may, in these examples, include information that indicates one or more levels of risk that the particular insurance policy presents to an insurer of the particular insurance policy. In such instances, providing the request to modify the information for the particular insurance policy may, for example, include providing a request to adjust the one or more levels of risk that the particular insurance policy presents to an insurer of the particular insurance policy that is indicated in the information for the particular insurance policy.

In some implementations, the multiple, different data sources may include one or more third-party web services and one or more devices that each include one or more sensing components.

In some examples, determining, based on the information for the particular insurance policy, that sensor data received from each of the multiple, different data sources is indicative of an occurrence of the particular event involving property that is covered by the particular insurance policy may include determining, based on the information for the particular insurance policy, that sensor data received from each of the multiple, different data sources at a particular point in time is indicative of an occurrence of a particular event involving property that is covered by the particular insurance policy. In response to determining that sensor data received from each of the multiple, different data sources is indicative of an occurrence of the particular event involving property that is covered by the particular insurance policy, the methods may, in these examples, further include the actions of identifying sensor data received from each of the multiple, different data sources between (i) a point in time having occurred before the particular point in time and (ii) the particular point in time. In addition, providing the message to one or more computing devices may, in such examples, include providing one or more representations of the identified sensor data for display on one or more computing devices.

In these examples, providing one or more representations of the identified sensor data for display on one or more computing devices may, in some implementations, include providing, through a graphical user interface of an application that is running on a computing device that is accessible to the insurance policyholder, a temporal representation of the identified sensor data.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a conceptual diagram of an example framework for identifying and responding to events associated with insurance policies.

FIG. 2 is a diagram of an example system for identifying and responding to events associated with insurance policies.

FIGS. 3A-3D illustrate example graphical user interfaces for presenting information that reflects identified events associated with insurance policies to one or more insurance customers.

FIGS. 4A-4C illustrate example graphical user interfaces for presenting information that reflects identified events associated with insurance policies to one or more insurance personnel.

FIG. 5 is a flow chart of an example process for identifying and responding to events associated with insurance policies.

FIG. 6 is a diagram of example computing devices.

Like reference symbols in the various drawings indicate like elements.

### DETAILED DESCRIPTION

In general, an aspect of the subject matter described in this specification may involve an analytics system for insurance providers and customers that leverages insurance information and residential sensor data (e.g., from Internet of Things devices) to identify and anticipate events associated with insurance customers and their insured property. The system may evaluate risks associated with appliance failures and other incidents of detriment to insured property and customers, and subsequently perform one or more operations to mitigate such risks, such as providing customers with event notifications, providing customers with incentives and recommendations regarding proactive maintenance practices for their insured property, instructing technicians and other insurance partners to inspect and repair appliances and homes of customers, remotely disabling or taking control of in-home appliances and devices that are determined to pose significant risk to customers, and the like.

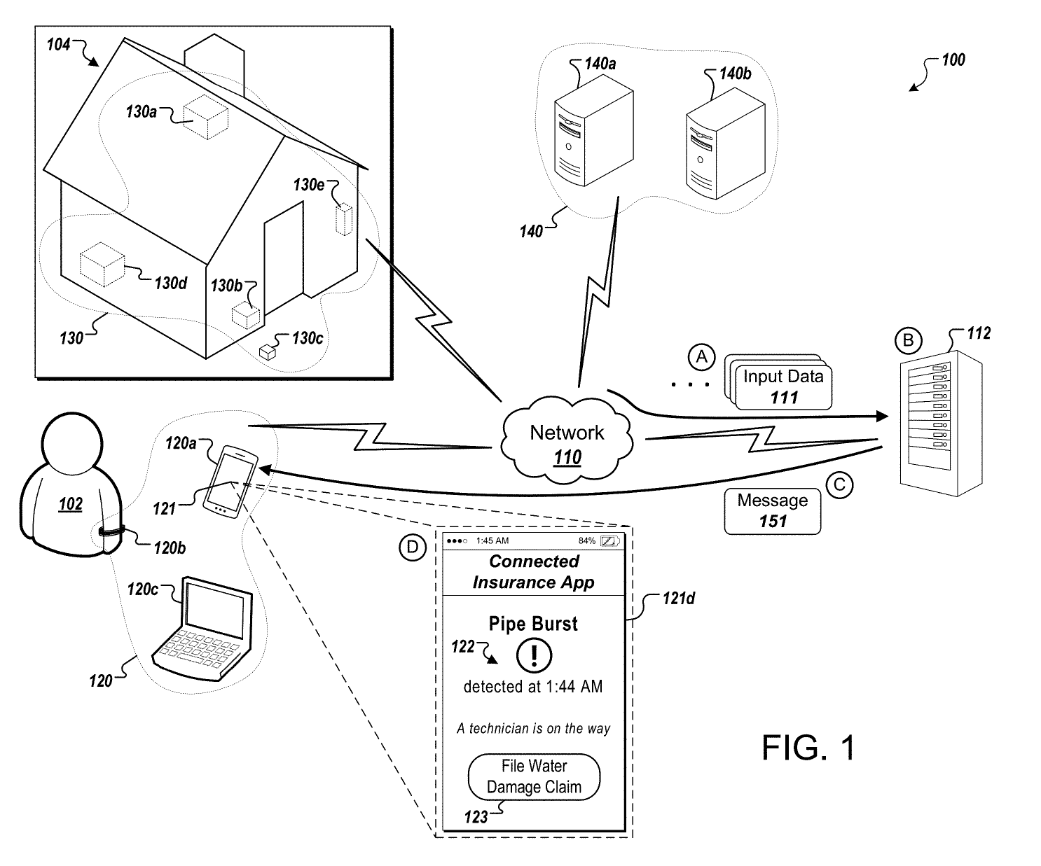

FIG. 1 is a conceptual diagram of an example system 100 that provides a framework for identifying and responding to events associated with insurance policies. More particularly, the diagram depicts a computing device 112 in communication with multiple, different data sources 120-140 over a network 110, that collectively make up system 100. The diagram also depicts exemplary data that is communicated within system 100 in stages “A” to “D,” respectively. Briefly, and as described in further detail below, the computing device 112 may detect occurrences of events involving insured property based on a feed of input data 111 that is received over network 110 from multiple, different data sources 120-140, and take one or more actions in response to detecting an occurrence of such an event.

The computing device 112 may, for instance, represent one or more servers in one or more locations that are accessible to an insurance company or other entity through which one or more customers hold any of a variety of different types of insurance policies (e.g., property insurance policies, auto insurance policies, health insurance policies, etc.). The computing device 112 may manage or otherwise maintain information for such insurance policies. In operation, the computing device 112 may receive a feed of input data 111 from multiple, different data sources 120-140, each of which may be directly or indirectly associated with one or more customers that hold such insurance policies and/or property that is covered by such insurance policies, and use collected input data 111 and information for such insurance policies to identify and respond to occurrences of events involving customers and/or insured property (e.g., theft, injury, property damage, etc.).

The multiple, different data sources 120-140 of system 100 may, for instance, include one or more user devices 120 belonging to customers that hold such insurance policies (e.g., smartphones, wearable computing devices, wearable health and fitness trackers, laptops, desktops, key fobs, devices that function as part of a vehicular system, etc.), and one or more onsite client devices 130 that are part of or located proximate to property that is covered by such insurance policies (e.g., appliances, set-top boxes, entertainment systems, short-range radio beacons and tags, sensors and other monitoring devices that function as part of a security and/or automation system, home controllers, utility metering devices, wireless gateways and other access points, etc.). The one or more onsite client devices 130 may, for instance, include devices that are installed or otherwise located within or around insured property and that monitor conditions and/or provide services within or around such insured property, while the one or more user devices 120 may, for instance, include devices that are mobile or otherwise transportable and that monitor conditions and/or provide services to one or more respective users. By communicating with both user devices 120 and onsite client devices 130, the computing device 112 may collect data from sensing devices that monitor conditions within a variety of different environments associated with insured property, customers, or a combination thereof.

In some implementations, the one or more onsite client devices 130 that are part of or located proximate to property that is covered by a particular insurance policy may include a hub device through which one or more of the other onsite client devices 130 communicate with the computing device 112. Although one or more of the user devices 120 belonging to the customer that holds the particular insurance policies may, in these implementations, also communicate with such a hub device while located within or proximate to property that is covered by the particular insurance policy, such user devices 120 may further communicate with the computing device 112 independent from the hub device while such user devices 120 are not located within or proximate to property that is covered by the particular insurance policy. In some examples, such a hub device may, for instance, correspond to a controller device functioning at the center of a security and/or automation system, a gateway device, a peripheral computing device communicatively coupled to such a controller device and/or gateway device, or a combination thereof.

The multiple, different data sources 120-140 may further include one or more web services 140 that are used by customers or are otherwise associated with customers and/or one or more environments within which insured property is located (e.g., social networking services, messaging services, news services, weather forecasting services, services provided by third parties that are partners of the insurance company, etc.). In some implementations, one or more servers, databases, and/or cloud computing devices may be relied upon to provide one or more of web services 140.

The input data 111 may, for instance, represent or include data having been captured by sensing components of one or more of user devices 120 and/or onsite client devices 130, data having been generated by applications that run on one or more of user devices 120 and/or onsite client devices 130, data provided by one or more of web services 140 that reflect one or more characteristics of customers and/or the environment within which insured property is located, or a combination thereof. Such sensing components may, in some implementations, each be configured to monitor one or more characteristics of systems included within a residence, one or more characteristics of systems included within a vehicle, and/or one or more characteristics of the surrounding environment, such as energy usage or consumption, operating temperature, operating frequency, fluid flow characteristics, motion detection, error messages, alerts, or other information.

In some examples, the computing device 112 may, for each of the insurance policies for which the computing device 112 manages information, store or otherwise maintain, in association with the information for the respective insurance policy, information about a subset of data sources 120-140 that are identified as being relevant to aspects of the respective insurance policy, property that is covered by the respective insurance policy, the customer that holds the respective insurance policy, and/or one or more of various types of events, the occurrences of which may be detected by computing device 112. The subset of data sources 120-140 identified for each insurance policy by the computing device 112 may, in some instances, change over time to accommodate for new data sources being introduced into system 100, existing data sources that no longer yield data of significant relevance, and various other factors. In addition, the computing device 112 may store portions of input data 111 that originate from such a subset of data sources 120-140 in association with the information that the computing device 112 manages for the respective insurance policy, and further rely upon such portions of input data 111 in determining whether events involving property that is covered by the respective insurance policy and/or the customer that holds the respective insurance policy have occurred or will occur.

In performing event detection, the computing device 112 may, in some implementations, leverage one or more statistical models that, in response to being provided with input data 111 from multiple, different data sources 120-140, may indicate, for each of the insurance policies for which the computing device 112 manages information, an estimated likelihood that each event in a set of predefined events has occurred or will occur in connection with the respective insurance policy. Such a set of predefined events may, for instance, include a variety of different incidents in which property that is covered by a given insurance policy malfunctions, is lost or stolen, sustains damage, and/or operates inefficiently, as well as incidents in which the customer that holds the given insurance policy and/or members of the customer's residence or family are injured or otherwise harmed.

For a given insurance policy, the one or more statistical models may, for example, output a confidence value for each event in a set of predefined events that reflects a level of confidence that input data 111, as collected from data sources 120-140, indicates that the respective event has occurred or will occur. In some examples, the computing device 112 may determine whether each confidence value that is output by the one or more statistical models exceeds one or more thresholds, and subsequently determine whether each event in a set of events has occurred or will occur based at least on whether the respective confidence value exceeds the one or more thresholds. The computing device 112 may, in some implementations, provide portions of input data 111 as input to the one or more statistical models in real-time, as each portion is received from data sources 120-140, such that the computing device 112 may evaluate up-to-date confidence values to determine whether any events have occurred or will occur in connection with a given insurance policy.

Upon determining that a particular event from among a set of events has occurred or will occur in connection with a given insurance policy, the computing device 112 may identify one or more operations that are to be performed responsive to detection of the particular event, and subsequently perform or otherwise enable the performance of the one or more identified operations. The computing device 112 may, for instance, maintain or otherwise have access to a set of rules that, for each event that may occur in connection with property that is covered by insurance policies for which the computing device 112 manages information, may indicate one or more operations that are to be performed in response to determining that input data 111 is indicative of an occurrence of the respective event. Examples of such operations may, for instance, include operations in which one or more suggestions or prompts are generated and provided to computing devices belonging to corresponding customers, operations in which one or more alerts or notifications are generated and provided to computing devices belonging to corresponding customers, insurance company personnel, and/or third party entities, operations in which one or more commands are generated and provided to one or more devices over network 110, operations in which one or more estimated levels of risk associated with insurance policies are adjusted, operations in which one or more insurance policy premiums are adjusted, and the like.

In the particular example depicted in FIG. 1, the insurance policies for which the computing device 112 manages or otherwise maintains information may, for instance, include an insurance policy that is held by user 102 and covers property 104. For example, user 102 may, as a customer of the insurer associated with the computing device 112, hold an insurance policy for property 104, which may represent the residence of user 102 and the possessions contained therein. In this way, the computing device 112 may leverage the feed of input data 111 and the information it maintains for this insurance policy to identify and respond to occurrences of incidents that may pose risk to the health and safety of user 102 and/or the condition of property 104.

In stage A, the computing device 112 may receive a feed of input data 111 from multiple, different data sources 120-140, and determine whether input data 111 is indicative of an occurrence of an event involving property 104 has occurred or will occur. That is, stage A may represent an indefinite period of time over which the multiple, different data sources feed input data 111 to the computing device 112 over network 110, and the computing device 112 continuously or intermittently monitors the input data 111 received for any indication that a known type of incident involving property 104 and/or user 102 has occurred or will occur. More specifically, the computing device 112 may, in stage A, receive a feed of input data 111 that at least includes data having originated from user devices 120a-c, onsite client devices 130a-e, and web services 140a-b, and determine whether input data 111 is indicative of an occurrence of an event involving property 104 has occurred or will occur based on information for the insurance policy held by user 102 that covers property 104 and/or information about data sources 120a-c, 130a-e, and 140a-b.

In the example of FIG. 1, user devices 120a-c may, for instance, belong to user 102 and include a smartphone 120a, a wearable health/fitness tracker 120b, and a laptop 120c. As such, the computing device 112 may receive, store, and analyze input data 111 in this stage that represents or includes data having been captured by sensing components of user devices 120a-c and/or having been generated by applications that run on user devices 120a-c. For example, the feed of input data 111 may indicate the geographic location of smartphone 120a as provided by a global positioning system (“GPS”) component of smartphone 120a, the heartrate of user 102 as provided by a heart rate monitoring component of wearable health/fitness tracker 120b, motion of smartphone 120a and/or wearable health/fitness tracker 120b as provided by accelerometer and/or gyroscope componentry of smartphone 120a and/or wearable health/fitness tracker 120b, one or more media access control (“MAC”) addresses of devices that are located within communicative vicinity of wireless communication componentry of smartphone 120a and/or laptop 120c, and the like.

Similarly, onsite client devices 130a-e may be part of or proximate to property 104 and, in this particular example, may include an appliance 130a, an electrical measurement device 130b that senses one or more characteristics of an electrical wiring system of property 104, a home automation/security device 130c that senses one or more environmental conditions of an exterior portion of property 104, a home automation/security device 130d that senses one or more environmental conditions of an interior portion of property 104, and a hub device 130e that obtains, processes, and aggregates data originating from other data sources and provides such aggregated data to the computing device 112 over network 110. In the example of FIG. 1, the computing device 112 may receive, store, and analyze input data 111 in this stage that represents or includes data having been captured by sensing components of onsite client devices 130a-e and/or having been generated by applications that run on onsite client devices 130a-e. For instance, the feed of input data 111 may indicate one or more operating conditions of appliance 130a, the amount of power being consumed through the electrical system of property 104 as determined by electrical measurement device 130b, one or more environmental conditions of property 104 including temperature levels, CO₂ levels, moisture levels, and/or smoke levels as detected by home automation/security device 130c and/or 130d, at the like.

In some examples, at least a portion of input data 111 representing or including data having originated from one or more of the onsite client devices 130a-d may be fed to the computing device 112 by hub device 130e, as mentioned above, in this stage. In addition, at least a portion of input data 111 representing or including data having originated from one or more of the user devices 120a-c may, in these examples, also be fed to the computing device 112 by hub device 130e, when the one or more user devices 120a-c are located within or around property 104, or are otherwise within communicative range of hub device 130e. Hub device 130e may be configured to communicate under a variety of different communication protocols such that hub device 130e may be able to request or otherwise obtain data from any of user devices 120a-c and onsite client devices 130a-d. Furthermore, hub device 130e may convert the data it receives from these data sources into one or more standardized formats that are compliant with the computing device 112, other computing devices on network 110, or a combination thereof. In these examples, hub device 130e may, for instance, aggregate data received from these data sources, as processed and/or reformatted by hub device 130e, and periodically transmit a package of input data 111 to the computing device 112 so as to relinquish such aggregated data. In this way, hub device 130e may coordinate and provide communication between data sources and the computing device 112 in a manner that conserves both power and network bandwidth in system 100.

In some implementations, hub device 130e may sense one or more conditions of the environment within which property 104 is located, and provide data that is indicative of such sensed conditions to the computing device with the feed of input data 111. For example, hub device 130e may identify user devices 120a-c, onsite client devices 130a-d, and other devices that are within wireless communicative range of hub device 130e, determine the received signal strengths (“RSSI”) of each identified device, and provide information indicative of such device identities and respective RSSIs to the computing device 112. In this way, the computing device 112 may be able to make many different determinations about the environment within which property 104 is located, such as those that are informative as to the RF fingerprint of the environment within which property 104 is located. The computing device 112 may, for example, be configured to detect events in connection with property 104 based on changes in the RF fingerprint of the environment within which property 104 is located. Similar information may be also be provided in system 100 by one or more wireless access points located within or around property 104. These techniques may also be used in system 100 to identify the presence of new devices in the environment within which property 104 is located, and subsequently provide user 102 with one or more messages suggesting that user 102 register such new devices in association with the insurance policy.

Web services 140a-b may be those that are used by user 102 or are otherwise associated with one or more environments within which user 102 or property 104 is located and, in the example of FIG. 1, may include a weather forecasting service 140a that provides current and projected weather data for one or more geographic regions that are of relevance to property 104 and/or user 102, and a social networking service 140b whose user base includes user 102 and/or other users located within one or more geographic regions that are of relevance to property 104 and/or user 102. In stage A, the computing device 112 may obtain input data 111 over network 110 that represents or includes data originating from web services 140a-b by, for instance, crawling or scraping one or more Internet resources that are hosted by web services 140a-b, communicating with web services 140a-b through one or more application programming interfaces (“APIs”), communicating directly with web services 140a-b, and the like. As such, the computing device 112 may receive, store, and analyze input data 111 in this stage that represents or includes data originating from web services 140a-b and may, for instance, indicate current and predicted weather conditions for the geographic region within which property 104 is located as provided by weather forecasting service 140a, current and predicted weather conditions for the geographic region within which user 102 is currently located and/or one or more geographic regions that user 102 is predicted to be located within at one or more future points in time as provided by weather forecasting service 140a, one or more social media posts having been shared through social networking service 140b by user 102, contacts of user 102, and/or other users located within one or more geographic regions that are of relevance to property 104 and/or user 102, and the like.

As the computing device 112 collects input data 111 from multiple, different data sources 120-140, including user devices 120a-c, onsite client devices 130a-e, and web services 140a-b, the computing device 112 may, in stage A, provide input data 111 as input to one or more statistical models such that output a confidence value for each event in a set of predefined events that reflects a level of confidence that input data 111, as collected from data sources including user devices 120a-c, onsite client devices 130a-e, and web services 140a-b, indicates that the respective event has occurred or will occur in connection with the insurance policy held by user 102 that covers property 104. Throughout stage A, the computing device 112 may, for instance, continuously or intermittently evaluate the confidence values that are indicated by the one or more statistical models against one or more thresholds to determine whether such an event has occurred or will occur.

In stage B, the computing device 112 may, for instance, determine that input data 111 received from data sources 120-140 is indicative of an occurrence of a particular event involving insured property 104 in which a pipe included within property 104 has burst. This may, for example, correspond to the computing device 112 having determined that the confidence value corresponding to a pipe burst incident, from among a set of confidence values indicated by the one or more statistical models and corresponding to a set of predefined events, respectively, exceeded one or more thresholds in stage B.

In this example, the computing device 112 may have reached this conclusion on the basis of one or more portions of input data 111 having originated from one or more of user devices 120a-c, onsite client devices 130a-e, and web services 140a-b, and having been received by the computing device 112 in and/or leading up to stage B. For example, some or all of onsite client devices 130a-e, which are part of or located proximate to property 104, may have fed data to the computing device 112 in and/or leading up to stage B that was at least in part indicative of a water pipe having burst within property 104. For instance, in an example in which the pipe burst incident is detected at 1:44 AM, one or more portions of input data 111 collected by the computing device 112 may indicate that communicative contact with appliance 130a was lost at 1:43 AM, and also indicate that one or more circuits of the electrical system of property 104 were shorted at 1:43 AM, as determined by electrical measurement device 130b. The loss of communicative contact with appliance 130a may, for example, be indicated in one or more portions of input data 111 having been produced by hub device 130e. That is, hub device 130e may have previously been communicating with appliance 130a, and may have produced such data in response to determining that an amount of time having elapsed since hub device 130e received data from appliance 130a exceeded one or more threshold amounts of time. In this instance, the computing device 112 may, through use of one or more statistical models, interpret the loss of communicative contact with appliance 130a and the shorted circuit detected by electrical measurement device 130b as being an indication that appliance 130a has experienced a malfunction as a result of circuitry that is electrically coupled to appliance 130a having shorted.

Since water damage is one possible cause of short circuits, such portions of input data 111 may serve to positively influence confidence values that correspond to events that involve water, such as pipe bursts, floods, leaks, hurricanes, and the like. That is, at 1:43 AM, one or more of the confidence values for water-related events that are obtained by the computing device 112 may have elevated at 1:43 AM as a result of input data 111 indicating the communicative failure of appliance 130a and shorted circuit in the electrical system of property 104.

Following the example described above, some or all of user devices 120a-c, which belong to user 102, may have also fed data to the computing device 112 at and/or leading up to 1:44 AM that was at least in part indicative of a water pipe having burst within property 104. For instance, one or more portions of input data 111 collected by the computing device 112 may further indicate that user 102 has been located within an interior portion of property 104 for several hours, as reflected in the GPS coordinates of smartphone 120a, and that user 102 fell asleep at 11:30 PM but was abruptly woken up at 1:43 AM, as reflected in motion data provided by accelerometer and/or gyroscope componentry of wearable health/fitness tracker 120b. The computing device 112 may, for example, also determine that such one or more portions of input data 111 indicate that user 102 has been located within an interior portion of property 104 for several hours by virtue of (i) receiving such one or more portions of input data 111 from hub device 112, and (ii) determining that such one or more portions of input data 111 represent or include data having originated from smartphone 120a, wearable health/fitness tracker 120b, or a combination thereof.

In isolation, the computing device 112 may, through use of one or more statistical models, interpret this sleep pattern of user 102 as being of little significance. However, in the presence of input data 111 indicating that, at 1:43 AM, user 102 was abruptly awoken, communicative contact with appliance 130a was lost, and one or more circuits of the electrical system of property 104 were shorted, the computing device 112 may, through use of one or more statistical models, interpret this sleep pattern of user 102 as being an indication that some sort of water-related event may have suddenly occurred in connection with property 104. Since the onset of a pipe burst is relatively sudden in nature, the confidence value for a pipe burst event that is obtained by the computing device 112 may have elevated at 1:43 AM such that it is greater than confidence values for other water-related events that develop in a relatively gradual manner, such as floods and leaks, as a result of input data 111 indicating user 102 being suddenly awoken, the communicative failure of appliance 130a, and shorted circuit in the electrical system of property 104.

Once again following the example described above, some or all of web services 140a-b, which are at least associated with one or more environments within which user 102 or property 104 is located, may have also produced data to the computing device 112 at and/or leading up to 1:44 AM that was at least in part indicative of a water pipe having burst within property 104. For instance, one or more portions of input data 111 collected by the computing device 112 may further indicate that, at 1:43 AM, the current weather conditions for the geographic region within which property 104 and user 102 are located include a light breeze with a 0% chance of rain, as provided by weather forecasting service 140a. In light of input data 111 indicating user 102 being suddenly awoken, the communicative failure of appliance 130a, and shorted circuit in the electrical system of property 104, the computing device 112 may, through use of one or more statistical models, interpret the these mild weather conditions as being an indication that that some sort of water-related event not caused by inclement weather conditions may have suddenly occurred in connection with property 104. For this reason, the confidence value for a pipe burst event that is obtained by the computing device 112 may, at 1:43 AM, have been greater than confidence values for other water-related events that are caused by inclement weather conditions, such as floods, hurricanes, and other storms.

In addition, one or more portions of input data 111 collected by the computing device 112 may further indicate that, at 1:44 AM, the level of moisture in an interior portion of property 104 has dramatically increased to a relatively high level, as detected by home automation/security device 130d, while the level of moisture in an exterior portion of property 104 is relatively low and stable, as detected by home automation/security device 130c. The computing device 112 may, through use of one or more statistical models, interpret the sharp increase in moisture level in the interior portion of property 104 as being a strong indication that a water-related event has indeed occurred, and also interpret the difference between the detected moisture level in the interior portion of property 104 and the detected moisture level in the exterior portion of property 104 as being an indication that the water-related event originated from within property 104. For this reason, the confidence value for a pipe burst event that is obtained by the computing device 112 may have elevated at 1:44 AM such that it exceeded one or more thresholds. That is, the moisture level pattern observed at 1:44 AM may have effectively triggered a determination by the computing device 112 that a pipe burst event has occurred in connection with the insurance policy held by user 102 that covers property 104.

In stage C, the computing device 112 may proceed to perform one or more operations in response to having detected such an event. In the example of FIG. 1, the computing device 112 may respond to having detected the pipe burst event by communicating with one or more computing devices over network 110. For instance, the computing device 112 may generate a maintenance request that includes information about the detected pipe burst incident, user 102, property 104, and the like, and provide the maintenance request to one or more computers of parties that are deemed to be capable of repairing pipe bursts, e.g., plumbers or technicians located within geographic vicinity of a location at which the pipe burst incident occurred. In this way, one or more emergency plumbers or technicians may be informed of the pipe burst incident and subsequently travel to property 104 to perform maintenance and/or other services to repair and restore property 104.

In this example, the computing device 112 may also, in stage C, generate and provide a message 151 to smartphone 120a over network 110. Message 151 may, for instance, be provided for display on smartphone 120a as an alert/notification indicating that a pipe burst event has been detected and that an emergency plumber or technician is on their way to provide help. The computing device 112 may have determined to provide message 151 to user 102 and, upon further determining, based on input data 111, that user 102 possesses smartphone 120a in stage C, the computing device 112 may have subsequently determined to provide message 151 to smartphone 120a so as to ensure that user 102 is notified in a quick and reliable manner. In some examples, the computing device 112 may provide message 151 to one or more computing devices that communicate with network 110 in place of or in addition to smartphone 120a.

Smartphone 120a may, for example, provide one or more screens 121 for display in stages A through C and, in response to receiving message 151 over network 110 in stage D, may provide screen 121d for display in place of the one or more screens 121 so as to alert/notify user 102 of the detected pipe burst event. Message 151 may also, in some examples, be presented on smartphone 120a as one or more push notifications. In some implementations, screen 121d may represent a screen that is provided for presentation through a user interface of an application running on smartphone 120a that may, for instance, be provided at least in part by the insurance company or other entity that manages the computing device 112. The computing device 112 may, for instance, communicate with such an application through one or more APIs.

As shown in FIG. 1, the screen 121d that is presented on smartphone 120a may, for instance, include one or more textual or graphical elements 122 indicating that a pipe burst event has was detected at 1:44 AM, and also that a technician is on their way to service property 104. In addition, the screen 121d that is presented on smartphone 120a may also include one or more user interface elements 123 that enable user 102 to file or otherwise initiate the process of filing an insurance claim in association with the insurance policy held by user 102 that covers property 104. In this example, based on computing device 112 having determined that property 104 has sustained or will sustain water damage as a result of the detected pipe burst event, message 151 that is provided to smartphone 120a may, for instance, include instructions for smartphone 120a to present one or more user interface elements 123 that enable user 102 to file a water damage claim.

In some implementations, smartphone 120a may present one or more forms to user 102 in response to receiving input through the one or more user interface elements 123 indicating that user 102 or another user associated with the insurance policy that covers property 104 would like to file a water damage claim. Such forms may, for instance, include one or more fields through which user 102 may provide information that is needed by the insurance company so that the water damage claim may be filed. In some examples, user 102 may be put in touch with one or more insurance agents or personnel that may assist with the preparation of such forms. In any case, smartphone 120a may provide one or more messages to the computing device 112 based on input that is received through one or more of such forms, the one or more user interface elements 123 or other user interface elements of the user interface through which screen 121d is presented, and the like. The computing device 112 may, in some implementations, store or otherwise maintain information about each claim that is filed for property 104 in association with the information that it stores or otherwise maintains for the insurance policy that covers property 104.

In some implementations, the computing device 112 may automatically complete (e.g., automatically determine values for filling out) one or more fields in an insurance claim form in response to receiving a request through one or more user interface elements 123 indicating the user 102 (or another user associated with the insurance policy that covers property 104) would like to initiate the process of submitting an insurance claim. The computing device 112 may receive the request indicating the user 102 would like to file an insurance claim and initiate filling out the insurance claim. For example, the computing device 112 may automatically insert the following into the insurance claim: the user 102's name, an address of the property 104, information regarding the user 102's insurance policy, the message 151 indicating a detected event, such as the pipe bursting, contact information for one or more insurance agents or personnel, contact information for the user 102, a time of the pipe burst event, as indicated by a high confidence value, and obtained values from each of the onsite client devices 130 at the time of the pipe burst event. The computing device 112 may fill out other fields in the one or more forms, the aforementioned list is provided for exemplary purposes.

In some implementations, the computing device 112 may automatically fill out one or more fields in the one or more forms of an insurance claim in response to the computing device 112 having determined that property 104 has sustained damage as a result of the detected event. The computing device 112 may transmit the automatically filled out insurance claim to the smart phone 120a for the user 102 to review. The smart phone 120a may prompt the user 102 to determine if the user 102 requests to file an insurance claim of the detected event. The prompt may be automatically presented to the user, for example, as a notification in a graphical interface on a screen of the smart phone 120a, or by audible or haptic feedback, or a combination of these. In some implementations, the user 102 can decline or accept filing the insurance claim by interacting with the one or more interface elements 123.

In some implementations, the user 102 may modify the values in form fields that were automatically filled out by the computing device 112. In particular, the user 102 may further add information pertaining to the one or more fields in the insurance claim. For example, the user 102, by way of interacting with the one or more user interface elements 123 presented on the smartphone 120a, may make changes to the message 151 indicating the detected event. The additional information may help the insurance company have a better understanding of a reason for the insurance claim. For example, the user 102 may file an insurance claim for water leakage from a pipe bursting, wind damage down to the outside of the home, home theft, or lightning strikes on the home, to name a few. Additionally, the user 102 may provide additional information so that the insurance company can determine a monetary cost to cover the insurance claim.

In some implementations, the user 102 may review the automatically filled in information in the one or more fields of the one or more forms for errors and correct the errors. For example, the user 102 may interact with the one or more user interface elements 123 presented on the smartphone 120a to delete and/or add information to the one or more fields of the one or more forms in the insurance claim. In some implementations, the computing device 112 may provide a notification to fill in one or more fields that the computing device 112 could not automatically fill in. For example, the computing device 112 may notify the smart phone 120a to prompt the user 102 to fill in one or more fields related to tax information of user 102, details regarding damage done to the property as a result of the event, such as the water pipe burst, because the computing device 112 did not have enough information to automatically fill in this information.

In some implementations, once the user 102 verifies that the form has been adequately completed to file an insurance claim, the user 102 may select one or more of the interface elements 123 to cause the smartphone 120a to transmit the data representative of the insurance claim to the insurance company. In addition, the smartphone 120a may transmit the data representative of the insurance claim to the computing device 112 for storage.

In some examples, one or more of the user devices 120, onsite client devices 130, and/or web services 140 may access the network 110 using a wireless connection, such as a cellular telephone data connection, a WI-FI connection, or other wireless connection that can be used for sending data to and receiving data from the computing device 112. In some implementations, the network 110 includes one or more networks, such as a local area network, a wide area network, and/or the Internet.

Such networks of network 110 may, for instance, include one or more wireless networks, such as cellular, infrared, WIFI, BLUETOOTH, ZIGBEE, RFID, NFC, and WIMAX networks, as well was one or more wired networks, such as power line communication (“PLC”) networks. In some implementations, one or more hub devices, such as hub device 130e, may serve as a bridge between two or more of the networks of network 110. As mentioned above, such a hub device may be configured to conduct communications under some or all of the communication protocols that are used in network 110, so as to collect data from a variety of different user devices 120 and onsite client devices 130.

In addition, the computing device 112 and/or one or more of the user devices 120, one or more onsite client devices 130, and/or one or more web services 140 may rely upon one or more remotely-located devices such as servers, databases, and/or cloud computing devices to perform at least a portion of the corresponding functions described herein. Such remotely-located devices may, for instance, communicate with network 110 or may communicate with the computing device 112 and/or one or more of the user devices 120, one or more onsite client devices 130, and/or one or more web services 140 over one or more other networks. In some examples, one or more hub devices, such as hub device 130e, may receive firmware updates from one or more remotely-located devices that enable such hub devices to communicate under new communication protocols, encode and decode new data formats, and the like. In this way, such a hub device may be able to continue to relay information between the computing device 112 and data sources as the environment of system 100 changes.

In some implementations, in addition to the computing device 112, user devices 120, onsite client devices 130, and/or one or more computing devices that operate in association with web services 140, system 100 may include one or more computing devices that communicate with network 110 or one or more other networks. Such other computing devices may, for instance, include computing devices that are accessible to or otherwise associated with contractors, technicians, emergency authorities, insurance agents or other insurance personnel, and/or other operations that are performed in connection with insurance policies. The computing device 112 may, for instance, in response to detecting one or more events in one or more stages similar to that which has been described above in reference to stage C, provide one or more messages to one or more of such other devices, user devices 120, onsite client devices 130, and/or web services 140. Although messages having been described above, such as message 151, may serve to alert/notify users of one or more computing devices, it is to be understood that messages serving a variety of different purposes may be provided response to detecting one or more events.

For instance, in a scenario in which the computing device 112 determines that an event in which an appliance of property 104 experiences one or more malfunctions or operational failures has occurred, the computing device 112 may provide one or more messages to such an appliance and/or one or more other devices that, when received over network 110, cause one or more operations to be performed to fix the malfunction/failure, remove power from such an appliance, and the like. That is, the computing device 112 may control one or more devices of property 104 so as to resolve the malfunction/failure and/or prevent the malfunction/failure from causing additional damage to property 104 or annoyance to user 102. Similar techniques may, for example, be provided so as to enable customers to use one or more computing devices, such as one or more of user devices 120, to remotely control one or more onsite client devices 130 over network 110. In this scenario, the computing device 112 may, in some instances, also provide one or more messages to contractors or technicians requesting that service be performed on such an appliance so as to fix or otherwise resolve the malfunction/failure or other event detected by the computing device 112. In some implementations, one or more messages may be provided to user 102 that instruct user 102 to take one or more actions to fix or otherwise resolve the malfunction/failure or other event detected by the computing device 112.

In a scenario in which the computing device 112 determines that an event in which an appliance of property 104 experiences one or more malfunctions or operational failures will occur at one or more future points in time, the computing device 112 may provide one or more messages to contractors or technicians requesting that service be performed on such an appliance so as to prevent the malfunction/failure or other event detected by the computing device 112 from occurring. For instance, the computing device 112 may provide one or more messages to schedule one or more service appointments with contractors or technicians. In some examples, the computing device 112 may, in such a scenario, provide one or more messages to user 102 suggesting that user 102 to take one or more actions to prevent the malfunction/failure or other event detected by the computing device 112 from occurring. For instance, system 100 may provide user 102 with one or more messages suggesting that user 102 replace an air filter used in an HVAC system of property 104, replace the batteries used in a smoke detector of property 104, replace a water pump of property 104, close one or more windows of property 104 in anticipation of a storm or other inclement weather affecting property 104, close or open one or more windows of property 104 so as to help user 102 save money on their electric bill and/or maintain a certain temperature in one or more interior portions of property 104, and the like.

In some implementations, such suggestions may be provided to user 102 along with indication of how about how, by taking the suggested actions, the premium that user 102 pays for the insurance policy covering property 104 may be lowered. In this way, system 100 may be seen as providing a sort of coaching function to its users that encourage insurance customers to perform maintenance that helps to mitigate occurrences of incidents, which in turn yields lower insurance premiums.

In some examples, the computing device 112 may provide users with insurance premium discounts upon determining that such users have performed suggested maintenance. That is, the computing device 112 may determine and maintain one or more levels of risk for each user, and update such levels upon determining that each user has taken one or more actions to mitigate occurrences of incidents. In addition, the computing device 112 may, in some implementations, develop a risk profile for each customer and/or insurance policy that indicates one or more levels of risk that the respective insurance policy presents to the insurance company. In such implementations, the computing device 112 may make one or more adjustments to each risk profile in response to detecting one or more events.

One or more of the events for which the computing device 112 monitors input data 111 may, in some instances, correspond to events in which customers/users exhibits specific behaviors that are considered to be indicative of an amount of risk such a customer/user may present to the insurance company. Such behaviors may, for instance, be predefined or learned by one or more of the models that are leveraged by the computing device 112. In this way, system 100 may be configured to identify new and undiscovered behaviors of customers/users that are relatively responsible and trustworthy, as well as behaviors of customers/users that pose substantial risk to the insurance company or other entity that manages the computing device 112. For example, by monitoring the habits of customers/users and observing the types and quantities of insurance claims filed by such customers/users, one or more of the models leveraged by the computing device 112 may learn to indicate relatively low risk levels for customers/users that, on average, wake up before 6:30 AM each day, and indicate slightly higher risk levels for customer/users that, on average, wake up after 6:30 AM each day, based on the existence of one or more correlations between the time at which customers/users wake up each day, as may indicated by data from wearable health and fitness trackers that are worn by customers/users, and the types and quantities of insurance claims such customers/users file. Examples of other types of data that may analyzed for such correlations may, for instance, include data that is received from a social networking service, data from user devices and/or onsite client devices that is indicative of a property's occupancy, and the like. In some examples, the computing device 112 may make one or more adjustments to a risk profile for a customer and/or insurance policy in response to identifying one or more of such behavioral events, and may thus also, in some implementations, make one or more adjustments to insurance premiums based on occurrences of such behavioral events. In addition, the computing device 112 may also provide customers/users with suggestions regarding how to change one or more of their habits so as to provide them with insurance premium savings.

The computing device 112 may, in some implementations, generate and store a chronological timeline of data from one or more of the data sources 120-140 having been produced leading up the detection of an event. As such, the computing device 112 may cache or otherwise store input data 111 as it is received, and retrieve such data in response to detecting an event. A representation of such a timeline may, for instance, be presented to customers/users and/or insurance personnel, and may be informative of one or more factors that contributed to the detection of the event. In this way, those who review such a representation may be able to perform a sort of root cause analysis on the detected event. Each timeline of data and/or representation may be provided to one or more computing devices on network 110 for presentation through the user interface of one or more applications that are running on such computing devices. In some examples, the computing device 112 and/or one or more other computing devices on network 110 may analyze such a timeline and provide an indication of a determined root cause of the detected event. In the example depicted in FIG. 1, a representation of such a chronological timeline of data may, for instance, indicate that, (i) at 1:43 AM, communication with appliance 130a was lost, one or more circuits of the electrical system of property 104 were shorted at 1:43 AM, and user 102 was abruptly woken up; and (ii) at 1:44 AM, the level of moisture in an interior portion of property 104 increased dramatically.

In some examples, the events for which the computing device 112 monitors input data 111 may, in some instances, one or more events in which a customer/user files an insurance claim in association with event that allegedly involves the property and/or insurance policy of the customer/user but was not detected by the computing device 112. In such examples, the computing device 112 may generate and store a chronological timeline of data from one or more of the data sources 120-140 having been produced leading up the filing of the insurance claim. Such a timeline may, for instance, be informative as to whether or not the filed insurance claim may be fraudulent, or may serve to help train one or more of the statistical models leveraged by the computing device 112 to recognize such occurrences of such an event in the future.

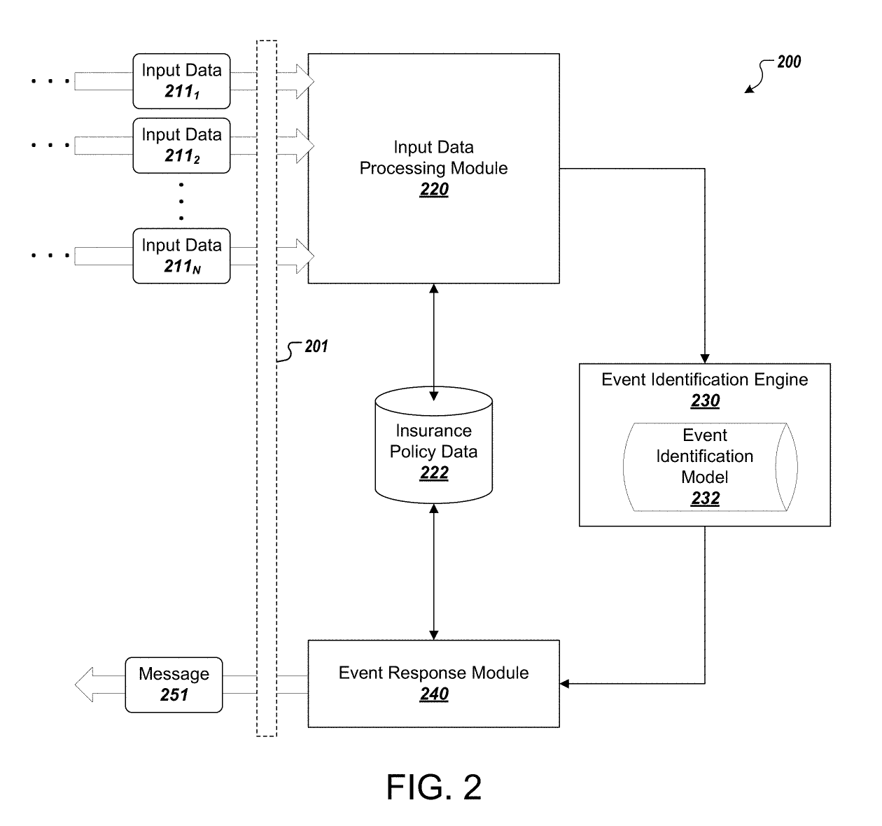

FIG. 2 depicts an example system 200 for identifying and responding to events associated with insurance policies. More particularly, FIG. 2 depicts system 200 including one or more interfaces 201, an input data processing module 220, an insurance policy data storage 222, an event identification engine 230, and an event response module 240. Although depicted as a singular system, the architecture of system 200 may be implemented using one or more networked computing devices. In some implementations, system 200 may be utilized to execute the processes described above in reference to the computing device 112 of FIG. 1. In other implementations, system 200 may be utilized by the hub device 130e utilizing the processes described above in reference to the computing device 112 of FIG. 1.

The input data module 220 may be a module that receives input from multiple, different data sources through one or more interfaces 201, processes the received input, and generates output that is provided as input to the event identification engine 230. In the example depicted in FIG. 2, the input data processing module 220 receives input data 211₁ to 211_{N} from each of N different data sources through one or more interfaces 201. Input data 211₁ to 211_{N} may, for instance, be received from N different data sources that are each similar to one or more of user devices 120, onsite client devices 130, and/or web services 140 as described above in reference to FIG. 1. The input data processing module 220 may access insurance policy information from the insurance policy data storage 222 and process input data received through one or more of the N feeds of input data accordingly. In some examples, the insurance policy data storage 222 may include information about how input data from a given one of the N different data sources is to be processed for analysis with respect to a given insurance policy.

The insurance policy data storage 222 may, for instance, include one or more databases within which information is stored for each of one or more insurance policies. Such information may, for instance, include information about the profile of the customer/user (e.g., name, age, marital status, etc.), information about property that is covered by the insurance policy (e.g., type, size, age, location, value, etc.), information about the details of the insurance policy (e.g., premiums, deductibles, types of property/events covered, etc.), information about data sources that are associated with the customer/user (e.g., user devices, onsite client devices, web services, etc.), information about the relevance of each data source to aspects of the insurance policy, data received from such data sources, one or more user preferences, claims filed by the customer/user, one or more levels of risk as determined for a risk profile that is associated with the customer/user and/or insurance policy, one or more operations that are to be performed by system 100 and/or other computing devices in response to detecting an event involving the insurance policy, and the like. The insurance policy data storage 222 may be accessible to one or more other components of system 200.

The input data processing module 220 may, for instance, apply one or more signal conditioning or processing to each of one or more of the feeds of 211₁ to 211_{N} so as to provide the event identification engine 230 with input that is of a suitable format. For example, the input data processing module 220 may perform natural language processing on some of all of the data it receives from web services so as to identify keywords, sentiment, and the like.

In some implementations, the input data processing module 220 may determine, for each insurance policy, a relevance score for each of one or more of the N different data sources that reflects the extent to which the respective data source is of relevance to one or more aspects of the insurance policy. For a given insurance policy, the relevance score determined for a given data source may, for example, reflect whether or not the given data source has been explicitly registered in association with the insurance policy, how far away the data source is located from the customer/user that holds the insurance policy and/or property that is covered by the insurance policy, how far away one or more locations referenced in data that is produced by the data source are from the customer/user that holds the insurance policy and/or property that is covered by the insurance policy, the frequency at which the customer/user that holds the insurance policy interacts with the data source and/or the frequency at which the data source communicates with one or more computing devices that are included in or around property that is covered by the insurance policy, or a combination thereof. The input data module 220 may, in some examples, facilitate one or more data source registration processes through which customers/users may be able to register user devices, onsite client devices, and/or web services in association with one or more insurance policies held by such customers/users.

In some examples, the input data processing module 220 may, for a given insurance policy, determine, for each of one or more of the N different data sources, a relevance score for each event that is detectable by the event identification engine 23 that reflects the extent to which the respective data source is of relevance to detecting an occurrence of the respective event in connection with the respective insurance policy. In these implementations, such relevance scores may be determined based on one or more of the abovementioned factors and/or other data. In any case, the input data processing module 220 may determine and adjust relevance scores based on input data 211₁ to 211_{N} as received through one or more interfaces 201 from each of N different data sources.

In some implementations, at least a portion of the processes described herein in reference to the input data processing module 220 may be performed by one or more hub devices. In the context of FIG. 1, at least a portion of these processes may, in these implementations, be performed by hub device 130e upstream from the computing device 112. For instance, one or more relevance scores may be determined or otherwise obtained by such a hub device so as to conserve power and bandwidth by only communicating data to the computing device 112 that is determined to be of sufficient relevance. In addition, a hub device, such as that which is similar to hub device 130e as described above in reference to FIG. 1, may perform one or more processes to register one or more data sources, such as those which are similar to user devices 120a-c and onsite client devices 130a-d as described above in reference to FIG. 1. That is, each user may be able to associate user devices and onsite client devices with their insurance policy by simply pairing these user devices and onsite client devices with such a hub device.

In these implementations, the hub device 130e may determine that the user 102 should file an insurance claim in response to detecting an occurrence of an event in connection with the insurance policy. For example, the hub device 130e may determine that the relevance score meets a predefined threshold score that indicates an appliance or data source on the property 104 has sustained damage as a result of a detected event, such as a water pipe bursting. In addition, like the statistical models of the computing device 112 mentioned above, the hub device 130e may similarly include one or more statistical models to predict and/or determine an indication of whether a detected event of damage has occurred, such as a water-related event. The hub device 130e may use the one or more statistical models to trigger a determination that the detected event has occurred and subsequently initiate the process of filing out an insurance claim.

In some implementations, a hub device, such as that which is similar to hub device 130e as described above in reference to FIG. 1, may perform one or more processes to automatically fill in one or more fields of one or more forms of an insurance claim in response to the hub device having determined that the property 104 has sustained damage as a result of the detected event. The hub device may perform similar processes to that of the computing device 112 including: providing an automatically filled out insurance claim form to user 102's smart phone 120a, receiving any adjustments the one or more fields in the one or more forms of the insurance claim, and providing the insurance claim to the insurance company and the computing device 112 once the form is completed. By the hub device performing these features, the hub device conserves the power and bandwidth of the computing device 112 so as to only communicate a completed insurance claim, rather than multiple communications back and forth between the smart phone 120a and the computing device 112.

The input data processing module 220 may provide input data from one or more of the feeds of input data 211₁ to 211_{N}, as processed, as input to the event identification engine 230. In some implementations, the input data processing module 220 may provide such input data, as processed for a given insurance policy, along with at least a portion of the information stored in insurance policy data storage 222 and/or one or more relevance scores having been determined for the data sources from which such processed input data originated, as input to the event identification engine 230.

The event identification engine 230 may receive data from the input data processing module 220, provide such data as input to one or more event identification models 232, obtain output from the one or more event identification models 232 including one or more confidence values that each reflect a level of confidence that such input indicates that a respective event has occurred or will occur in connection with a given insurance policy, determine whether each of the one or more confidence values exceed one or more thresholds, and provide output to the event response module 240 that indicates the outcome of such a determination. In some implementations, the one or more event identification models may include one or more statistical models that function in manner similar to that which has been described above in reference to the one or more statistical models that may be leveraged by the computing device 112 of FIG. 1.

In some examples, such one or more statistical models may be generated, maintained, and modified using one or more machine learning techniques, such as supervised learning, unsupervised learning, and reinforcement learning. For example, the one or more statistical models may include artificial neural network and logistic regression models. The one or more event identification models 232 may, for instance, be trained using training data that includes one or more (i) insurance claims having been filed for events involving an insurance policy, a customer/user that holds the insurance policy, and/or property that is covered by the insurance policy, and (ii) data having been received from multiple, different data sources before and/or at the time at which such events occurred. In this way, the one or more event identification models 232 may be configured to recognize patterns in input data from one or more of the feeds of input data 211₁ to 211_{N} that may be indicative of an occurrence of an event. In some implementations, the one or more event identification models 232 may include one or more statistical models or portions thereof that correspond to specific insurance policies for which information is stored in the insurance policy data storage 222. In some examples, the one or more event identification models 232 may be trained using training data that further includes one or more relevance scores as determined by the input data processing module 220. At runtime, such relevance scores may, in some implementations, be used to adjust one or more weights of the event identification model 232 or bias input data to which such relevance scores correspond in one or more other ways. The one or more event identification models 232 may, in some instances, be continually trained using new and up-to-date data as produced by or in association with system 200. As such, the one or more event identification models 232 may become more accurate over time.

The event identification engine 230 may obtain confidence values as output from the one or more event identification models 232, and may evaluate such values so as to determine whether any events have likely occurred or are anticipated to occur. For instance, the event identification engine 230 may compare each confidence value produced by the one or more event identification models 232 to each of one or more thresholds. Such thresholds may, for instance, include one or more thresholds that are defined by the insurance company or other entity that manages system 200, developed for specific users, insurance policies, and events, or a combination thereof. The input data processing module 220 and the event identification module 230 may, for instance, be seen as performing one or more of the processes as described above in reference to stages A and B. Upon determining that a confidence value exceeds such one or more thresholds, the event identification engine 230 may provide output to the event response module 240 that indicates that the event to which the confidence value corresponds has occurred or will occur in connection with a given insurance policy. In some implementations, the event identification engine 230 may include a classifier that processes input confidence values from the event identification model 232 or data from source sensing devices and determines a classification for these input parameters that represents one or more of a plurality of pre-defined events to which the input parameters correspond.

The event response module 240 may receive output from the event identification engine 230, determine one or more operations that are to be performed in response to event identification engine 230 having detected one or more events, and enable the one or more operations to be performed. In the example depicted in FIG. 2, the event response module 240 provides one or more messages 251 as output through one or more interfaces 201 in response to event identification engine 230 having detected one or more events. The event response module 240 may, for instance, be seen as performing one or more of the processes as described above in reference to stage C. The one or more messages 251 may, for instance, be provided to one or more computing devices over a network similar to that which has been described above in reference to network 110 of FIG. 1. The event response module 240 may consult the insurance policy data storage 222 to determine the appropriate response to take for a given event. For example, the event response module 240 may determine, based on data received from the event identification engine 230 and information included in the insurance policy data storage 222, that one or more messages 251 are to be provided to a specific computing device that is registered as being the primary device of the customer/user that holds the insurance policy that is associated with the detected event. In this example, the event response module 240 may subsequently generate the one or more messages 251, and provide such messages for transmission through one or more interfaces 201 to the appropriate one or more computing devices.

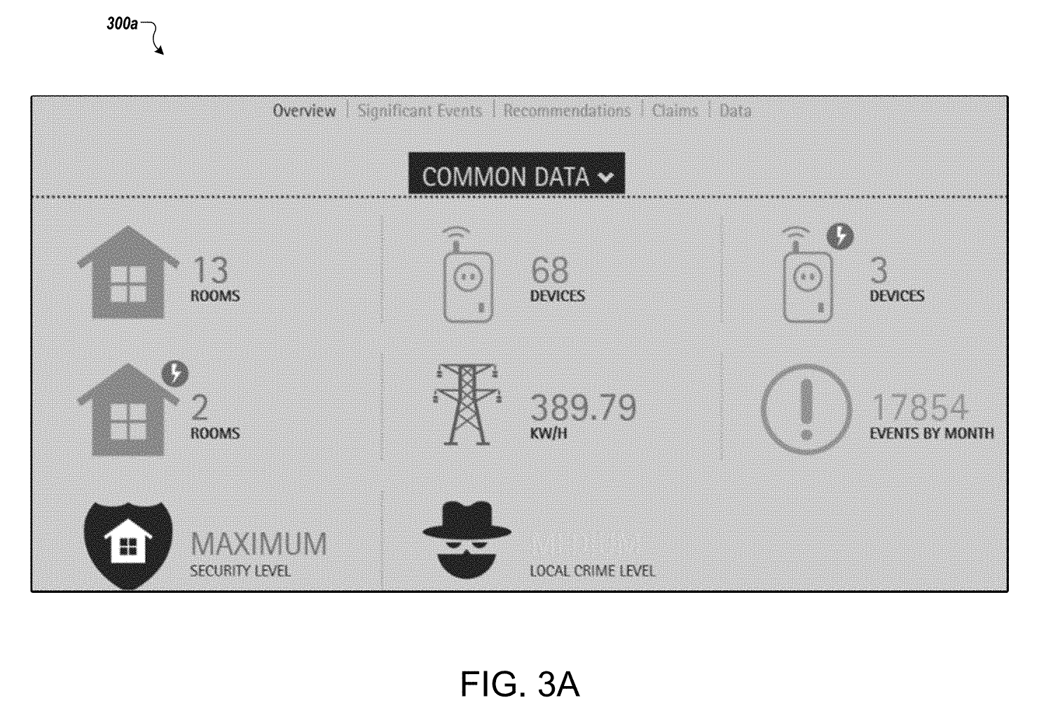

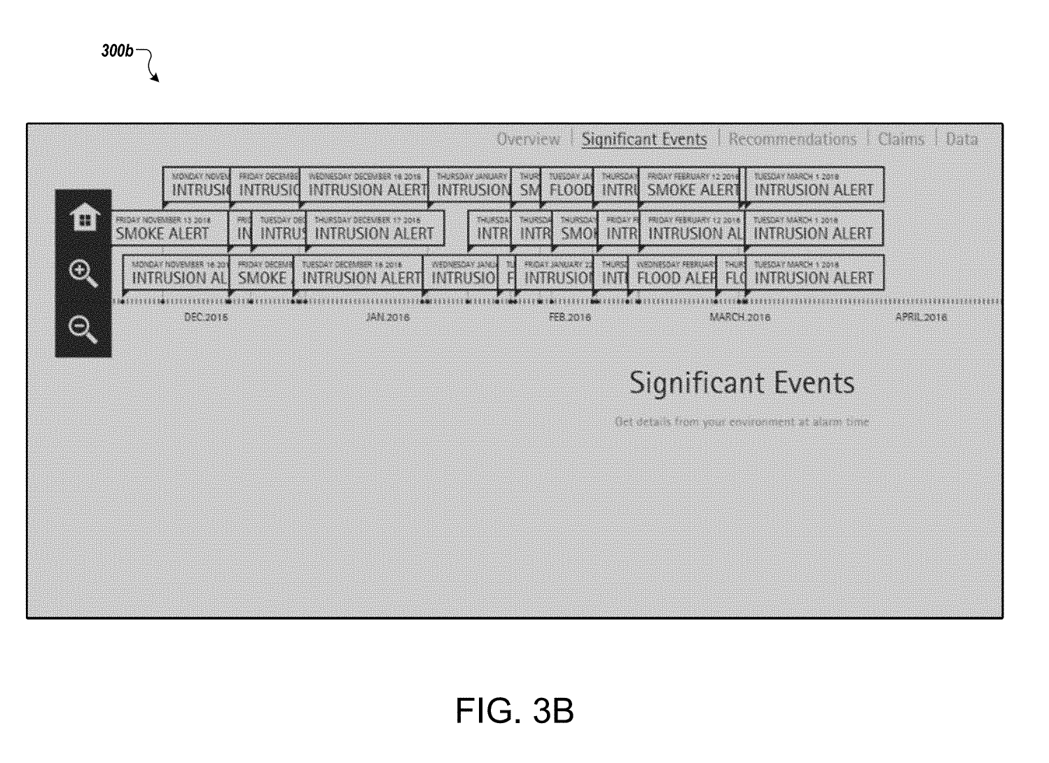

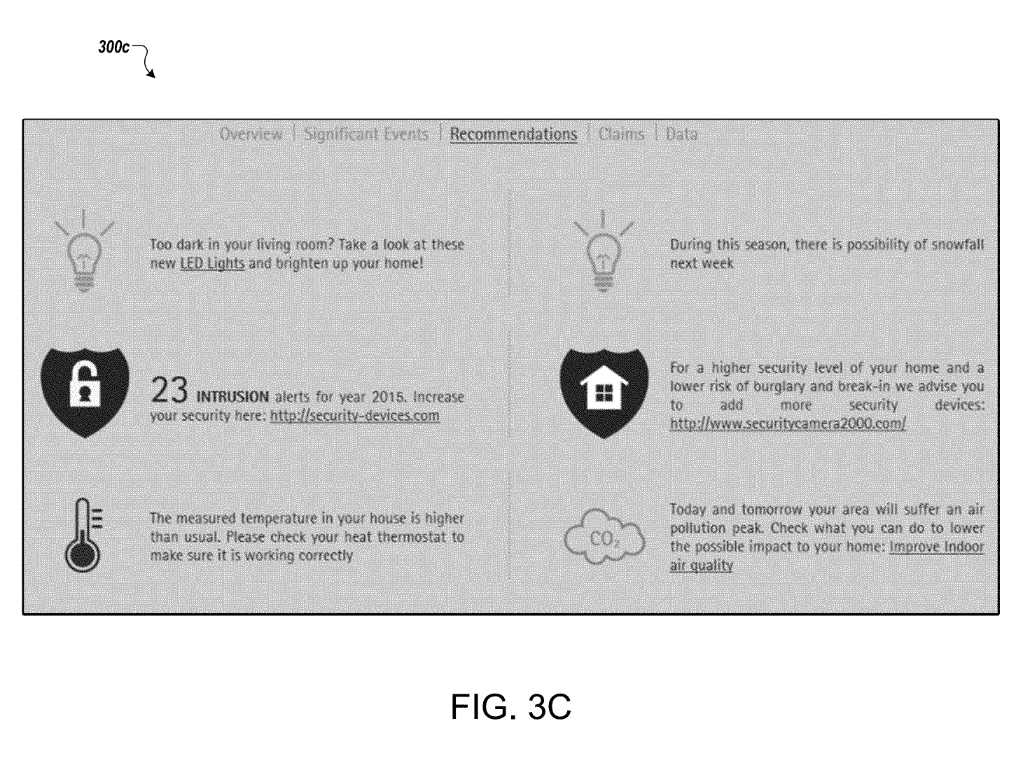

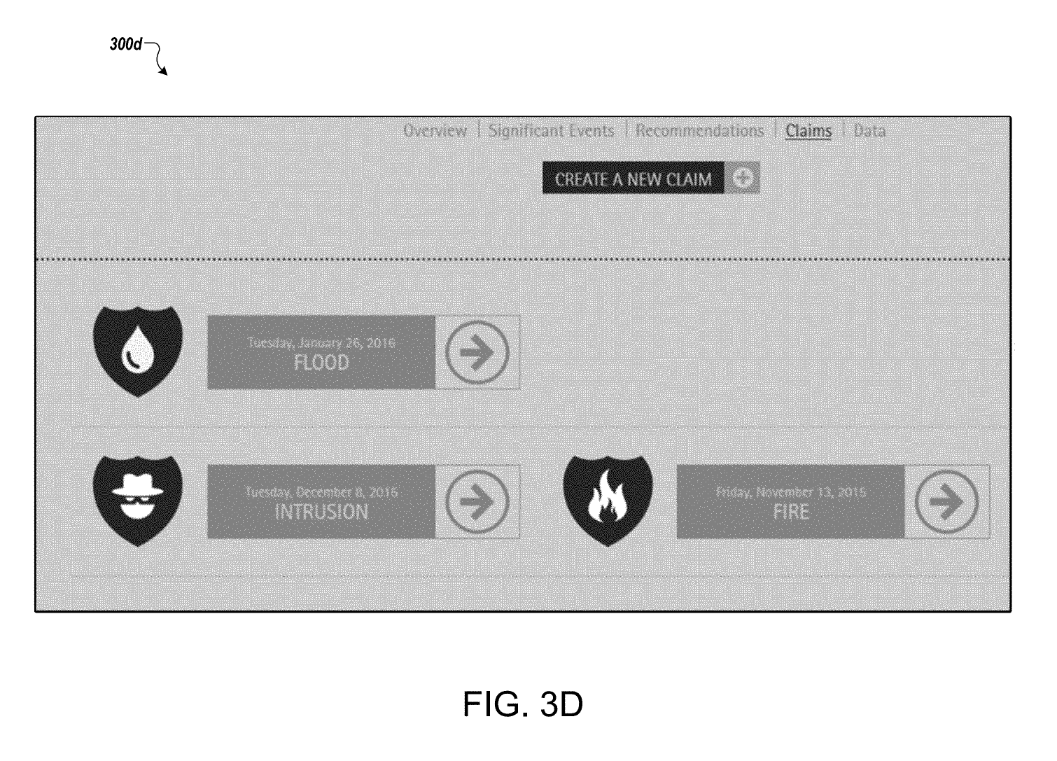

FIGS. 3A-3D illustrate example graphical user interfaces 300a-300d for presenting information that reflects identified events associated with insurance policies to one or more insurance customers. Graphical user interfaces 300a-300d may, for example, represent user interfaces that are provided to a customer/user, similar to those having been described above in reference to FIGS. 1 and 2, by an application running on a computing device that is being accessed by the customer/user. The information presented through each of graphical user interfaces 300a-300d may, for instance, represent information having been produced in system 100 and/or 200, as described above in reference to FIGS. 1 and 2, based on one or more events having been detected and/or input data having been received from multiple, different data sources.

For instance, graphical user interface 300a may present an informational overview of an insured property, the current level of security of the insured property, the data sources that are associated with the insured property, utility usage statistics for the insured property, crime rate statistics for the geographic region within which the insured property is located, the number of events having detected at the insured property, and the like. Graphical user interface 300b may, for instance, present a chronological timeline having been generated to represent data having been captured from one or more data sources leading up to a detected event, or a chronological timeline of events having been detected. Graphical user interface 300c may present one or more recommendations having been determined based on data received from one or more data sources. Such recommendations may, for instance, provide the customer/user with one or more suggestions regarding how to save money on insurance premiums and/or utilities, be better prepared for occurrences of events, and the like. Graphical user interface 300d may, for instance, present information regarding claims having been previously filed in association with the insured property. In some examples, graphical user interface 300d may further include one or more user interface elements that enable the customer/user to create and file a new insurance claim.

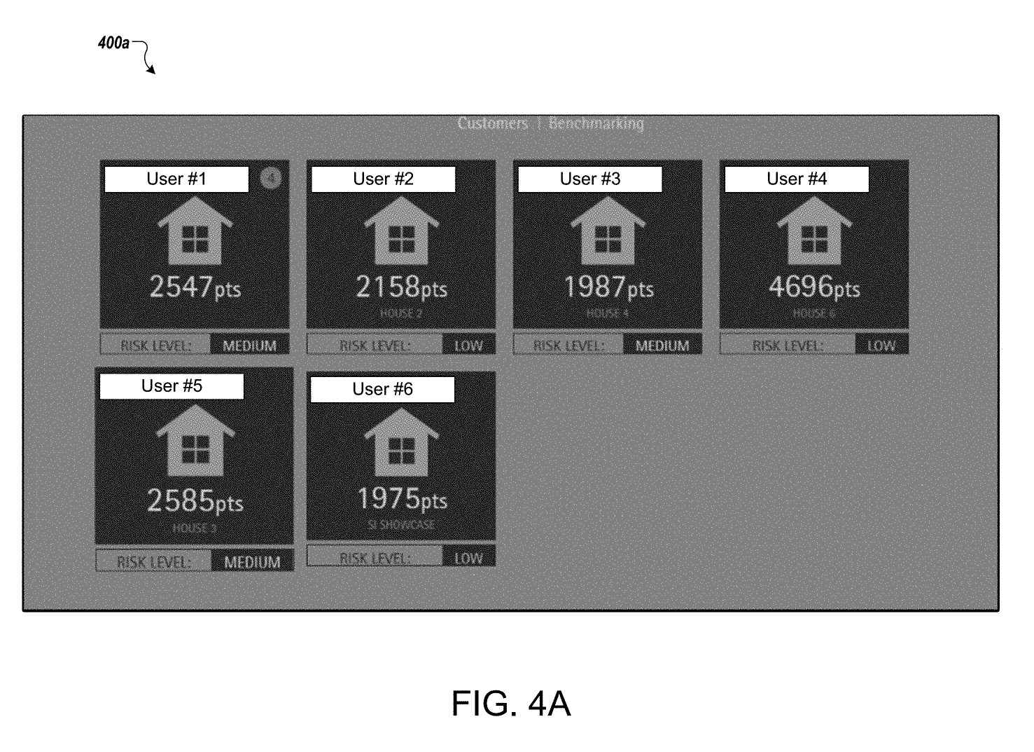

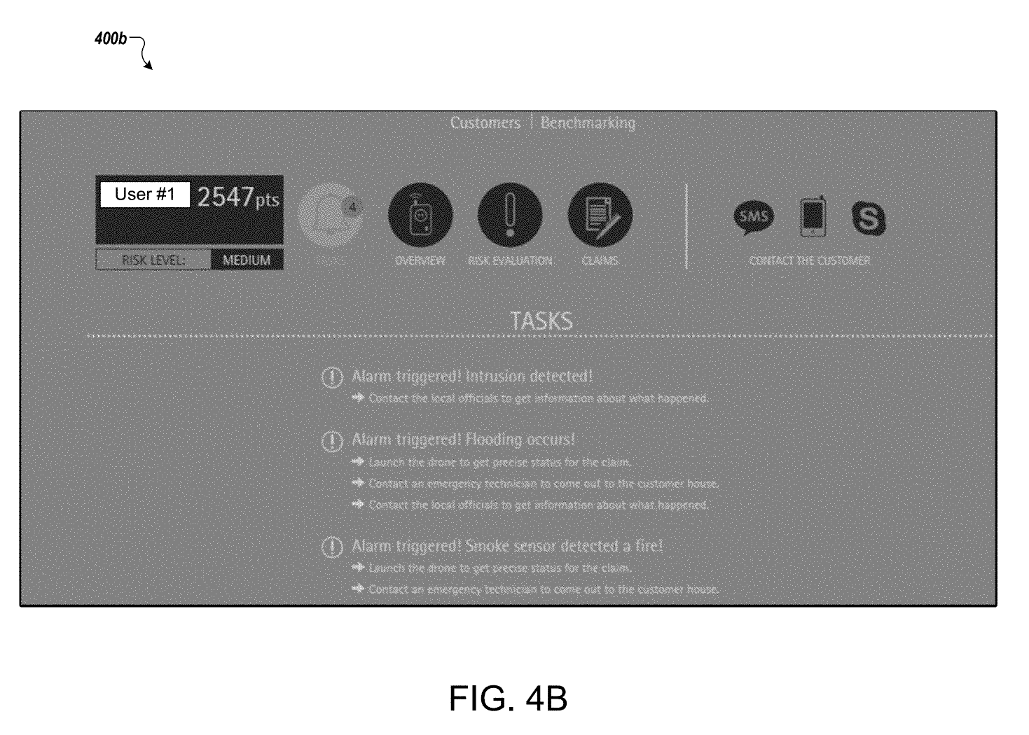

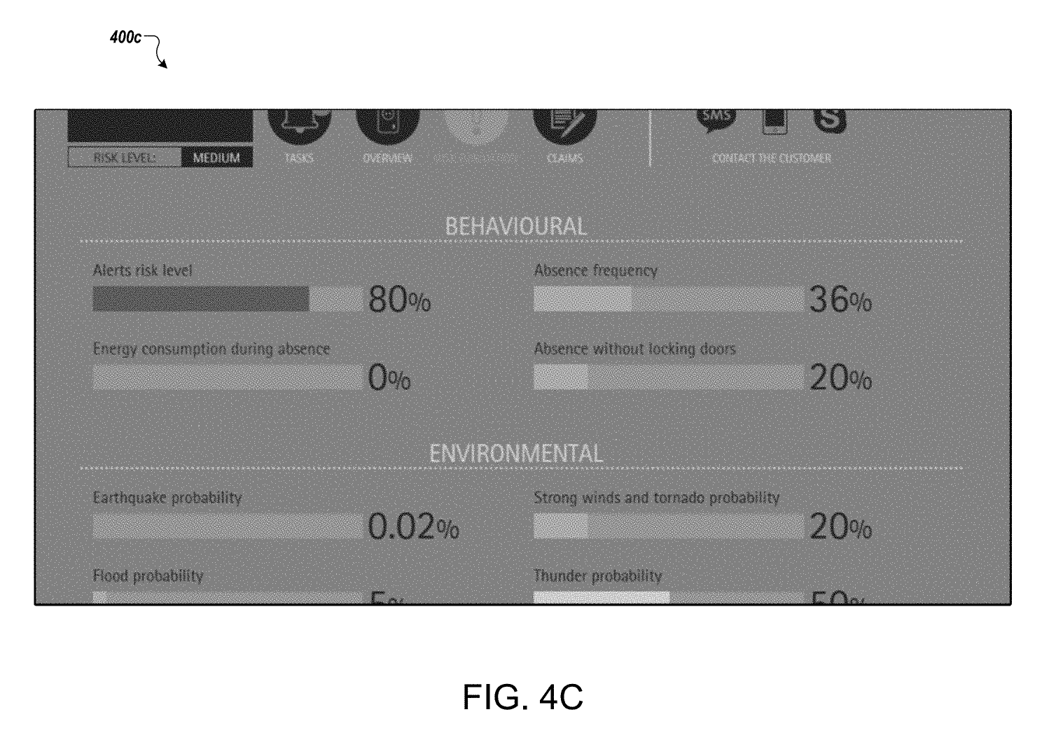

FIGS. 4A-4C illustrate example graphical user interfaces 400a-400c for presenting to one or more insurance personnel information that reflects identified events associated with customers' insurance policies. Graphical user interfaces 400a-400c may, for example, represent user interfaces that are provided to insurance personnel, such as agents and others that may work for an insurance company or other entity that manages at least a portion of the components as described above in reference to FIGS. 1 and 2, by an application running on a computing device that is being accessed by such insurance personnel. The information presented through each of graphical user interfaces 400a-400c may, for instance, represent information having been produced in system 100 and/or 200, as described above in reference to FIGS. 1 and 2, based on one or more events having been detected and/or input data having been received from multiple, different data sources.

Graphical user interface 400a may, for instance, present risk profiles determined for each of multiple, different insurance customers. Such customers may, for instance, include those who live in the same neighborhood. In addition, graphical user interface 400a may present one or more other metrics for each customer having been determined based on input data received from multiple, different data sources. Graphical user interface 400b may provide insurance personnel with an overview of detected events involving a specific insurance policy, along with one or more sets of information indicative of tasks that the insurance personnel may perform so as to address such events. In some examples, graphical user interface 400b may provide one or more user interface elements that, upon receiving input from insurance personnel, initiate the performance of one or more operations to address such events. Graphical user interface 400c may, for instance, present a variety of statistics having been derived based on input data received from multiple, different data sources. Such statistics may reflect detected occurrences of events and/or one or more attributes associated therewith, and may serve as a basis on which one or more operations may be performed to mitigate risk, prevent occurrences of events, and the like.

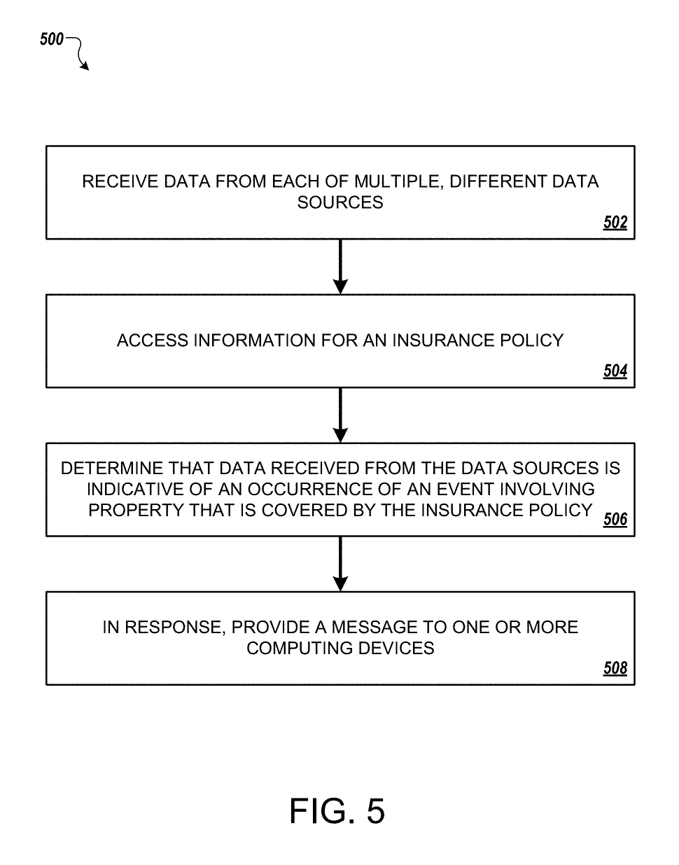

FIG. 5 is a flowchart of an example process 500 for identifying and responding to events associated with insurance policies. The following describes the process 500 as being performed by components of systems that are described with reference to FIGS. 1-4C. However, process 500 may be performed by other systems or system configurations. Briefly, the process 500 may include receiving data from each of multiple, different data sources (502), accessing information for an insurance policy (504), determining that data received from the data sources is indicative of an occurrence of an event involving property that is covered by the insurance policy (506), and in response, providing a message to one or more computing devices (508).

The process 500 may include receiving data from each of multiple, different data sources (502). This may, for instance, correspond to the computing device 112 or to the hub device 130e, as described above in reference to FIG. 1, receiving input data 111 from multiple, different data sources 120-140 in stage A.

The process 500 may include accessing information for a particular insurance policy (504). For example, this may correspond to one or more components of system 200, as described above in reference to FIG. 2, accessing information that included in the insurance policy data storage 222.

The process 500 may include determining, based on the information for the particular insurance policy, that data received from each of the multiple, different data sources is indicative of an occurrence of a particular event involving property that is covered by the particular insurance policy (506). This may, for instance, correspond to the computing device 112 or to the hub device 130e, as described above in reference to FIG. 1, determining in stage B that a water pipe event has occurred in connection with property 104.

The process 500 may include, in response to determining that data received from each of the multiple, different data sources is indicative of an occurrence of the particular event involving property that is covered by the particular insurance policy, providing a message to one or more computing devices (508). For example, this may correspond to the computing device 112 or to the hub device 130e, as described above in reference to FIG. 1, providing, in stage C, message 151 to smartphone 120a so as to present an alert/notification to user 102. In some implementations, additional or alternative remedial actions may be taken in response to determining that data received from the various data sources is indicative of an occurrence of an event covered by an insurance policy. For example, the computing device 112, or the hub device 130e, may transmit a signal to a power controller that is capable of adjusting an amount of power delivered to one or more of the data sources or other appliances in the network. The signal may instruct the power controller to adjust parameters of a power delivery profile for a particular appliance or data source related to the detected event, e.g., to prevent overheating or to mitigate risk of an electrical fire. For example, the power delivered to an appliance may be reduced or deactivated in response to detecting an event relevant to the customer's insurance policy. In instances that the system automatically provides a notification or alert to a customer's personal computing device (e.g., smartphone), the notification may be supplemented with hyperlinks and other interface elements that a user can select to contact vendors or service providers, or an insurance agent, to assist with an aftermath of the event.

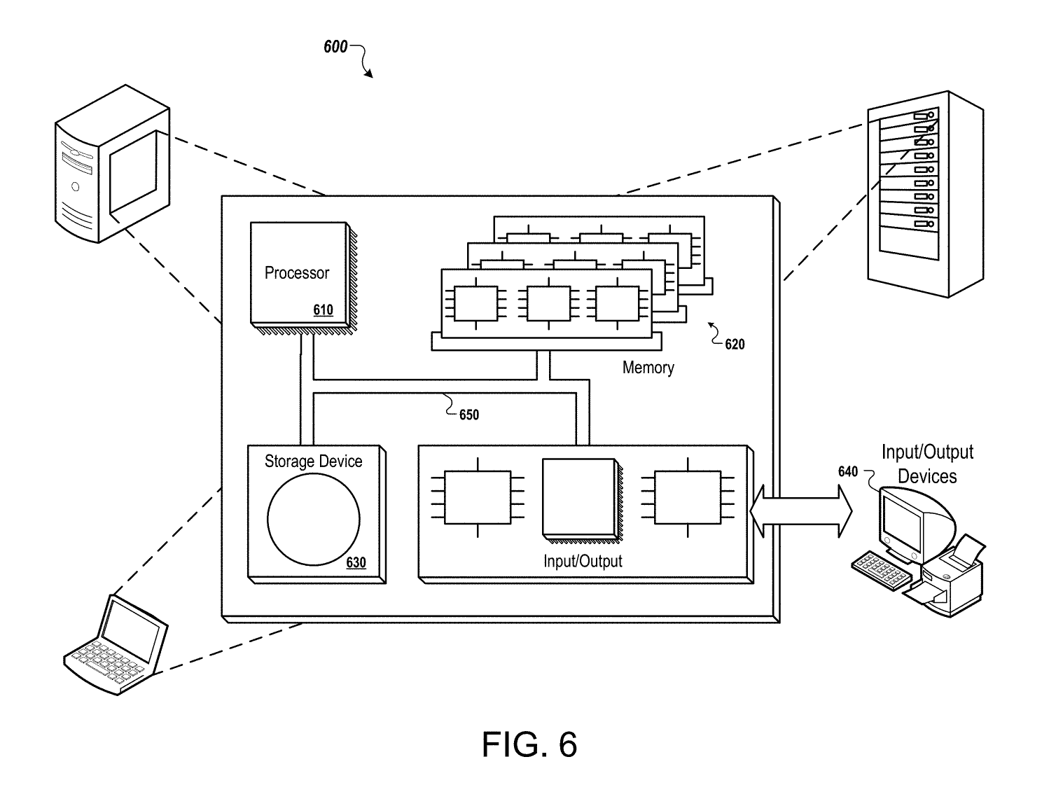

FIG. 6 is a schematic diagram of an example of a computer system 600. The system 600 can be used for the operations described in association with FIGS. 1-5 according to some implementations. The system 600 may be included in the system 100 and/or 200.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
receiving, by a computing system, sensor data from each of multiple, different data sources, the sensor data representing a condition of an environment associated with an insurance policyholder;
accessing, by the computing system, information for a particular insurance policy of the insurance policyholder;
determining, by the computing system and based on the information for the particular insurance policy, that the sensor data received from each of the multiple, different data sources is indicative of an occurrence of a particular event involving property that is covered by the particular insurance policy; and
in response to determining that the sensor data received from each of the multiple, different data sources is indicative of an occurrence of the particular event involving property that is covered by the particular insurance policy, providing a message to one or more computing devices.

2. The computer-implemented method of claim 1, further comprising:
obtaining a relevance score for each of the multiple, different data sources indicating an estimated level of relevance that sensor data received from the respective data source has to the particular insurance policy; and
wherein determining, based on the information for the particular insurance policy, that sensor data received from each of the multiple, different data sources is indicative of an occurrence of the particular event involving property that is covered by the particular insurance policy comprises:
determining, based on the relevance scores obtained for each of the multiple different data sources and the information for the particular insurance policy, that sensor data received from each of the multiple, different data sources is indicative of an occurrence of a particular event involving property that is covered by the particular insurance policy.

3. The computer-implemented method of claim 2, further comprising:
determining, for each of the multiple, different data sources, whether the respective data source corresponds to a device that is registered to the insurance policyholder; and
wherein obtaining the relevance score for each of the multiple, different data sources indicating an estimated level of relevance that sensor data received from the respective data source has to the particular insurance policy comprises:
obtaining a relevance score for each of the multiple, different data sources, based on determining whether the respective data source corresponds to a device that is registered to the insurance policyholder.

4. The computer-implemented method of claim 2, further comprising:
determining, for each of the multiple, different data sources, whether sensor data received from the respective data source reflects one or more characteristics of an environment within which property that is covered by the particular insurance policy is located; and
wherein obtaining the relevance score for each of the multiple, different data sources indicating an estimated level of relevance that sensor data received from the respective data source has to the particular insurance policy comprises:
obtaining a relevance score for each of the multiple, different data sources, based on determining whether sensor data received from the respective data source reflects one or more characteristics of the environment within which property that is covered by the particular insurance policy is located.

5. The computer-implemented method of claim 1, wherein determining, based on the information for the particular insurance policy, that sensor data received from each of the multiple, different data sources is indicative of an occurrence of a particular event involving property that is covered by the particular insurance policy comprises:
accessing a neural network that has been trained to identify occurrences of events involving insured property given (I) sensor data from one or more data sources and (II) information for an insurance policy;
providing input to the neural network that includes (i) sensor data received from each of the multiple, different data sources and (ii) information for the particular insurance policy; and
receiving, as output from the neural network, data identifying the particular event involving property that is covered by the particular insurance policy.

6. The computer-implemented method of claim 5, further comprising:
accessing information for another, different insurance policy;
providing input to the neural network that includes (i) sensor data received from each of the multiple, different data sources and (ii) information for the other insurance policy; and
receiving, as output from the neural network, data identifying another, different event involving property that is covered by the other insurance policy.

7. The computer-implemented method of claim 1,
wherein receiving sensor data from each of multiple, different data sources comprises:
receiving sensor data from one or more appliances; and
wherein accessing information for the particular insurance policy comprises:
accessing information for a particular insurance policy covering property that includes on the one or more appliances.

8. The computer-implemented method of claim 7, wherein determining, based on the information for the particular insurance policy, that sensor data received from each of the multiple, different data sources is indicative of an occurrence of the particular event involving property that is covered by the particular insurance policy comprises:
determining, based on the information for the particular insurance policy, that sensor data received from each of the multiple, different data sources is indicative of an occurrence of a particular incident in which a particular one of the appliances experiences one or more failures.

9. The computer-implemented method of claim 8, wherein providing the message to one or more computing devices comprises:
providing one or more commands to the particular appliance.

10. The computer-implemented method of claim 8, further comprising:
selecting, from among a multiple, different third party entities that are each associated with one or more respective events involving insured property, a particular third party entity that is associated with the particular incident; and
wherein providing the message to one or more computing devices comprises:
providing, to one or more computing devices that are accessible to the particular third party entity, a request to perform one or more services that are associated with the particular incident.

11. The computer-implemented method of claim 1, wherein providing the message to one or more computing devices comprises:
providing, to one or more computing devices that are accessible to the insurance policyholder, a message suggesting that the insurance policyholder take one or more actions to prevent or suppress an occurrence of the particular incident.

12. The computer-implemented method of claim 1, further comprising:
selecting, from among multiple, different types of insurance claims that are each associated with one or more respective events involving insured property, a particular type of insurance claim that is associated with the particular event; and
wherein providing the message to one or more computing devices comprises:
providing an indication of the particular type of insurance claim to one or more computing devices that are accessible to (i) the insurance policyholder, or (ii) an agent that manages the particular insurance policy.

13. The computer-implemented method of claim 1,
wherein the information for the particular insurance policy is stored in one or more databases; and
wherein providing the message to one or more computing devices comprises:
providing, to one or more computing devices that manage the one or more databases, a request to modify the information for the particular insurance policy.

14. The computer-implemented method of claim 13,
wherein the information for the particular insurance policy includes information that indicates the particular insurance policy's premium; and
wherein providing the request to modify the information for the particular insurance policy comprises:
providing a request to adjust the premium of the particular insurance policy that is indicated in the information for the particular insurance policy.

15. The computer-implemented method of claim 13,
wherein the information for the particular insurance policy includes information that indicates one or more levels of risk that the particular insurance policy presents to an insurer of the particular insurance policy; and
wherein providing the request to modify the information for the particular insurance policy comprises:
providing a request to adjust the one or more levels of risk that the particular insurance policy presents to an insurer of the particular insurance policy that is indicated in the information for the particular insurance policy.

16. The computer-implemented method of claim 1, wherein the multiple, different data sources include one or more third-party web services and one or more devices that each include one or more sensing components.

17. The computer-implemented method of claim 1,
wherein determining, based on the information for the particular insurance policy, that sensor data received from each of the multiple, different data sources is indicative of an occurrence of the particular event involving property that is covered by the particular insurance policy comprises:
determining, based on the information for the particular insurance policy, that sensor data received from each of the multiple, different data sources at a particular point in time is indicative of an occurrence of a particular event involving property that is covered by the particular insurance policy;
wherein the computer-implemented method further comprises, in response to determining that sensor data received from each of the multiple, different data sources is indicative of an occurrence of the particular event involving property that is covered by the particular insurance policy:
identifying sensor data received from each of the multiple, different data sources between (i) a point in time having occurred before the particular point in time and (ii) the particular point in time; and
wherein providing the message to one or more computing devices comprises:
providing one or more representations of the identified sensor data for display on one or more computing devices.

18. The computer-implemented method of claim 17, wherein providing one or more representations of the identified sensor data for display on one or more computing devices comprises:
providing, through a graphical user interface of an application that is running on a computing device that is accessible to the insurance policyholder, a temporal representation of the identified sensor data.

19. A computer program product, encoded on one or more non-transitory computer storage media, comprising instructions that when executed by one or more computers cause the one or more computers to perform operations comprising:
receiving, by the one or more computers, sensor data from each of multiple, different data sources, the sensor data representing a condition of an environment associated with an insurance policyholder;
accessing, by the one or more computers, information for a particular insurance policy of the insurance policyholder;
determining, by the one or more computers and based on the information for the particular insurance policy, that the sensor data received from each of the multiple, different data sources is indicative of an occurrence of a particular event involving property that is covered by the particular insurance policy; and
in response to determining that the sensor data received from each of the multiple, different data sources is indicative of an occurrence of the particular event involving property that is covered by the particular insurance policy, providing a message to one or more computing devices.

20. A system comprising:
one or more computers and one or more storage devices storing instructions that are operable, when executed by the one or more computers, to cause the one or more computers to perform operations comprising:
receiving, by the one or more computers, sensor data from each of multiple, different data sources, the sensor data representing a condition of an environment associated with an insurance policyholder;
accessing, by the one or more computers, information for a particular insurance policy of the insurance policyholder;
determining, by the one or more computers and based on the information for the particular insurance policy, that the sensor data received from each of the multiple, different data sources is indicative of an occurrence of a particular event involving property that is covered by the particular insurance policy; and
in response to determining that the sensor data received from each of the multiple, different data sources is indicative of an occurrence of the particular event involving property that is covered by the particular insurance policy, providing a message to one or more computing devices.
